(19) United States
(12) Patent Application Publication
(10) Pub. No.: US 2009/0296045 A1
(43) Pub. Date: Dec. 3, 2009

(54) ILLUMINATION SYSTEM

(75) Inventors: Hsin-Hsiang Lo, Hsinchu County (TW); Chun-Chuan Lin, Hsinchu City (TW); Shuang-Chao Chung, Taoyuan County (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 12/237,481

(22) Filed: Sep. 25, 2008

(30) Foreign Application Priority Data
May 30, 2008 (TW) 097120308

(51) Int. Cl. G02B 27/28; G02B 27/10

(52) U.S. Cl. 353/20; 353/31

(57) ABSTRACT

An illumination system includes at least one light source capable of generating light of at least three wavelength sections; at least three integrator modules for receiving the light of each wavelength section and performing a uniformization process on the light of each wavelength section; at least three first lens modules for receiving the after the uniformization process light and converging angles of the light into a predetermined range; a light coupling module for receiving the converged light and performing a light-coupling process on the light; and a polarization conversion module for receiving the coupled light and performing a polarization conversion process on the light.

### CROSS-REFERENCE TO RELATED APPLICATIONS

This non-provisional application claims priority under 35 U.S.C. § 119(a) on Patent Application No(s). 097120308 filed in Taiwan, R.O.C. on May 30, 2008 the entire contents of which are hereby incorporated by reference.

### BACKGROUND OF THE INVENTION

1. Field of the Invention

The present invention relates to an illumination system. More particularly, the present invention relates to an illumination system with coupled light and polarized light.

2. Related Art

With the improved luminous efficiency and high color performance capability of light emitting diodes (LED), many projection systems with a liquid crystal display (LCD), a liquid crystal on silicon (LCoS), or a digital mirror device (DMD) as a display element began to utilize the LED as the light source of projection display devices.

In many light source illumination projection display devices, in order to pursue high-brightness and high-color-rendering output of the projection display devices, many projection display devices has polarization conversion mechanisms or red, green, blue light coupling mechanisms disposed therein. However, in such structures, the two mechanisms cannot be integrated perfectly, thus causing over-sized elements, difficulties in fabrication, or poor conversion efficiency.

Referring to US Patent Publication No. 20060164726, after condensing red, green, blue light sources by three integrators and a light-mixing element, the un-polarized light are converted into polarized light through a polarization conversion mechanism, and then enter into a light-mixing and illumination light path of a large integrator, so as to be projected onto a panel, as that in a conventional structure. The polarization conversion mechanism separates the P polarized light and the S polarized light with a set of prisms. However, the angle of the light from the small integrator is too large, thus causing a burden of the polarization conversion mechanism, and reducing the conversion efficiency. Further, the light polarized by the polarization conversion are mixed by a large integrator, and the continuous reflection of the light confuses the direction of the polarized light after process, thus reducing the conversion efficiency.

Referring to U.S. Pat. No. 5,748,376, a reflection mask is used to focus the light source to mix in an integrator. The integrator has a polarization film adhered thereon for primary polarization, and light spots are imaged on a polarization conversion element. However, in practice, it wastes time to make the integrator to have the polarization film, and the polarization effect is limited after the light is reflected for many times. Further, LEDs become one of the main light sources gradually due to long life and high color rendering. Therefore, as for large emitting angle, the effect is limited regardless of using reflection mask or polarization film.

Referring to US Patent Publication No. 20060023167, in an array LED light source with a curved arrangement, red, green, blue three array light sources are converged by a light coupling element, and a polarized light is generated by a polarization conversion mechanism and an energy recovery system and then projected onto a panel. In the patent application, it is emphasized that, the light coupling element is used to couple the red, green, blue array light sources. Although the patent application converges the light into the light coupling element in the manner of curved arrangement to avoid a light loss of edge LEDs, the reflection efficiency or penetration efficiency of the light coupling element has close relationship with the angle, that is, when a larger angle results in a reduced reflection efficiency or penetration efficiency, thus causing the light loss.

Referring to U.S. Pat. No. 7,036,937, a light source is focused into an integrator by a reflection mask, and a virtual image of the light source is imaged on a polarization conversion element by a lens to perform polarization conversion, and finally is projected onto a panel. With advantages of long life and good color rendering of the LED light source, projection systems gradually use LEDs as main light sources. However, for large divergence angle of LED, the use of the reflection mask in the patent is still limited, and in the patent, the light coupling mechanism of the red, green, blue three primary colors is not emphasized.

### SUMMARY OF THE INVENTION

The present invention is directed to an illumination system with functions of light coupling and polarized light conversion, which includes at least one light source, capable of generating light of at least three wavelength sections; at least three integrator modules, for receiving the light of the wavelength sections and performing a uniformization process on the light of the wavelength sections; at least three first lens modules, for receiving the light after the uniformization process and converging angles of the light into a predetermined range; a light coupling module, for receiving the converged light and performing a light-coupling process on the light; and a polarization conversion module, for receiving the light after the light-coupling process and performing a polarization conversion process on the light.

In view of the above, the illumination system of the present invention improves the efficiency of subsequent light processes (such as, light coupling and polarized light conversion) by converging the angles of light through the lens modules. Moreover, the three light sources are separated with the light coupling module, thus addressing the problem of heat dissipation of high power light sources or array LED light sources, thereby improving the color of the illumination system through the light coupling module.

### BRIEF DESCRIPTION OF THE DRAWINGS

The present invention will become more fully understood from the detailed description given herein below for illustration only, and thus are not limitative of the present invention, and wherein:

FIG. 1A is a schematic structural view of a first embodiment according to the present invention;

FIG. 1B is a schematic structural view of a second embodiment according to the present invention; and

FIG. 2 is a schematic view of the corresponding relationship between the incident angle and the light intensity according to the present invention.

### DETAILED DESCRIPTION OF THE INVENTION

Features of the present invention are illustrated with reference to embodiments of the present invention exemplified hereinafter with the following drawings.

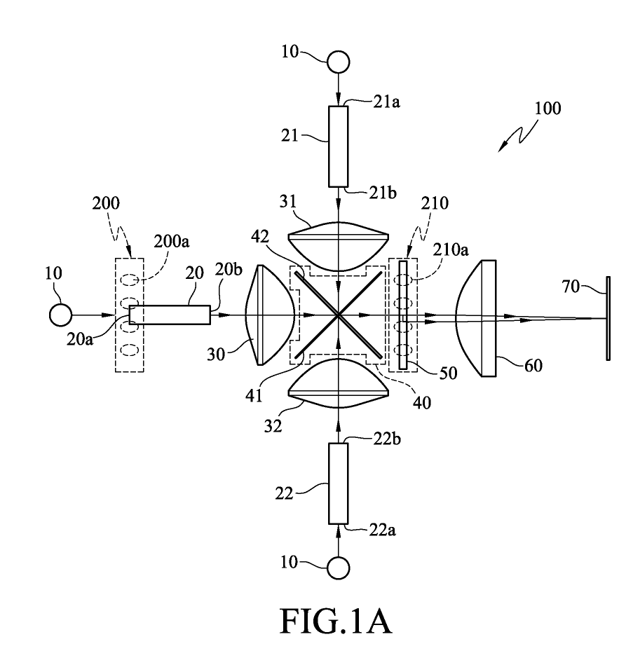

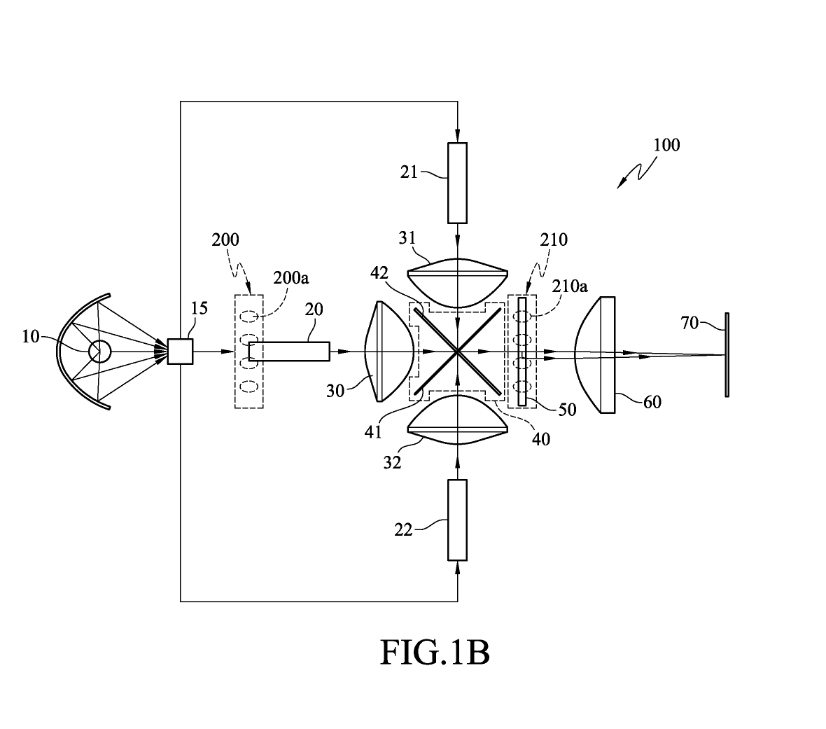

FIG. 1A is a schematic structural view of a first embodiment according to the present invention. Referring to FIG. 1A, an illumination system 100 of the present invention includes a light source 10, a first integrator module 20, a second integrator module 21, a third integrator module 22, a first lens module 30, a first lens module 31, a first lens module 32, a light coupling module 40, a polarization conversion module 50, a second lens module 60, and a liquid crystal panel 70.

The light source 10 is capable of generating light of at least three wavelength sections, for example, a first wavelength section is from 620 nm to 750 nm, a second wavelength section is from 495 nm to 570 nm, a third wavelength section is from 450 nm to 495 nm, and the whole section of the first wavelength section, the second wavelength section, and the third wavelength section covers the visible light section. The light source 10 can be, for example, a light emitting diode (LED) or an organic LED.

The first integrator module 20, the second integrator module 21, and the third integrator module 22 are corresponding to the light of the wavelength sections respectively. The first integrator module 20, the second integrator module 21, and the third integrator module 22 receive the light of the wavelength sections and perform a uniformization process on the light of the wavelength sections. Hereinafter, the first integrator module 20 is taken as an example to illustrate the uniformization process.

The light is reflected in the first integrator module 20. As the incident light entering the first integrator module 20 have different angles, the numbers of reflection thereof in the first integrator module 20 are different. For example, the light that is reflected in the first integrator module 20 once forms a virtual light source 200a when the reflected light is conversely induced, such that a virtual light source array 200 is generated on an entrance face 20a. The virtual light sources 200a irradiates an exit face 20b at different angles, thus a uniform irradiation distribution is obtained on the exit face 20b.

Therefore, each integrator module (i.e., 20/21/22) has an entrance face 20a/21a/22a and an exit face 20b/21b/22b. Taking the first integrator module 20 as an example, the entrance face 20a receives the light generated by the light source 10, and a virtual light source array 200 is formed on the entrance face 20a, and the light exited from the exit face 20b pass through the corresponding first lens module 30. In other words, after passing through the first lens module 30, the first lens module 31, the first lens module 32 corresponding to each integrator module (i.e., 20/21/22), the light of each integrator module (i.e., 20/21/22) exited from the exit face 20b forms a real light source array 210 corresponding to the virtual light source array 200. The polarization conversion module 50 is disposed on a position of the real light source array 210. Further, the uniformization processes of the second integrator module 21 and third integrator module 22 are the same as that of the first integrator module 20, and will not be repeated herein.

The first lens module 30, the first lens module 31, the first lens module 32 are corresponding to the first integrator module 20, the second integrator module 21, and the third integrator module 22 respectively. The first lens module 30 receives the light after the uniformization process by the first integrator module 20 and converges the angle of the light into a predetermined range, for example, in prior art, preferred polarization conversion property is achieved when the angle is between ±10 or ±8 degrees, referring to the embodiment of FIG. 1A, when the art is progressed in the future, the converged angle can be greater than ±10 degrees. The processes of the first lens modules 31 and 32 are the same, and will not be repeated herein.

The light coupling module 40 is disposed between the first lens module 30, the first lens module 31, and the first lens module 32. The light coupling module 40 receives the converged light and couples the light. The light coupling module 40 includes a first filter element 41 and a second filter element 42. The first filter element 41 and the second filter element 42 are substantially perpendicular to each other. The first filter element 41 reflects the light of the first wavelength section to the polarization conversion module 50 and allows the light of the second wavelength section and the light of the third wavelength section to pass there-through. The second filter element 42 reflects the light of the third wavelength section to the polarization conversion module 50 and allows the light of the second wavelength section and the light of the first wavelength section to pass there-through. The first wavelength section is from 620 nm to 750 nm (red), the second wavelength section is from 495 nm to 570 nm (green), and the third wavelength section is from 450 nm to 495 nm (blue). The light coupling module 40 can be, for example, an un-polarized coupler.

Further, as the three light sources are separated by the light coupling module 40, the problem of heat dissipation of high power light sources or array LED light sources can be solved. However, common light sources are un-polarized light, so it is preferred to use a light coupling module 40 of un-polarized light. It should be noted that, the angle of the light coupling module 40 is also limited, and an over-large incident angle results in the reduced reflection ratio or penetration ratio, thus leading to non-uniform light coupling or brightness. Therefore, from the above description, the angles of the light are compressed into 10 degrees by the first lens module 30, the first lens module 31, and the first lens module 32, so as to reduce the loss of the penetration ratio or the reflection ratio of the un-polarized light coupling module 40.

The polarization conversion module 50 is disposed at a side of the light coupling module 40 and at the position of the real image light source array 210. The polarization conversion module 50 receives the light after the light-coupling process and performs a polarization conversion process on the light. The polarization conversion process refers to separating the light into two polarization states and allowing the light of a special polarization state to pass through, and converting the light of the special polarization state.

For example, the polarization conversion module 50 allows the first polarized light of the light and reflects the second polarized light of the light, and the reflected second polarized light is converted into the first polarized light through polarization. The first polarized light can be, for example, an S polarized light or a P polarized light, which depends on the specification of the polarization conversion module 50.

Further, it can be known from geometrical optics that, the light source 10 can form many virtual light sources through the first integrator module 20, the second integrator module 21, and the third integrator module 22. A virtual light source 200a is a virtual light source generated by the first integrator module 20, and can simplify the entire illumination system 100 into many light spots, which are focused on the polarization conversion module 50 through the first lens module 30, the first lens module 31, and the first lens module 32. However, the first lens module 30, the first lens module 31, and the first lens module 32 must meet the following two conditions to achieve the optimal polarization conversion efficiency: (1) the telecentric condition of the polarization conversion module 50; and (2) entering the polarization conversion module 50 at a small angle (for example, smaller than ±10 degrees).

The first integrator module 20, the second integrator module 21, and the third integrator module 22 image the virtual light source 200a of the virtual light source array 200 formed by the entrance face 20a on the polarization conversion module 50 after passing through the first lens module 30, the first lens module 31, and the first lens module 32, so as to form a real light source array 210 including the real light source 210a. The focal lengths and the positions of the first lens module 30, the first lens module 31, and the first lens module 32 must meet the condition that the main light of the virtual light sources 200a are incident in parallel onto the polarization conversion module 50. In other words, the polarization conversion module 50 should be disposed on the position of the real light source array 210.

Meanwhile, the polarization conversion efficiency of the polarization conversion module 50 mainly depends on the incident angle, generally, when the angle is smaller than ±10 degrees or ±8 degrees, the polarization conversion has a efficiency of 1.75 times, so the polarized light conversion efficiency can be adjusted by adjusting the positions of the first lens module 30, the first lens module 31, and the first lens module 32.

The second lens module 60 is disposed at the light emitting side of the polarization conversion module 50. Thus, the light emitted from the polarization conversion module 50 are completely the first polarized light (or the second polarized light, which depends on the optical property of the polarization conversion module 50). After being converged by the second lens module 60, the light after the polarization conversion process are stacked on the liquid crystal panel 70.

FIG. 1B is a schematic structural view of a second embodiment according to the present invention. Referring to FIG. 1B, a light source 10 of the second embodiment can be, for example, a halogen lamp, various arc lamps, a high pressure mercury lamp, a metal halide lamp, a xenon lamp, and an LED. Therefore, a light splitting element 15 is required to separate the light generated by the light source 10 into light of different wavelength sections, and introduce the light of the wavelength sections into each of the integrator modules. Other modules have the same structures and optical principles as those of first embodiment, and will not be repeated herein.

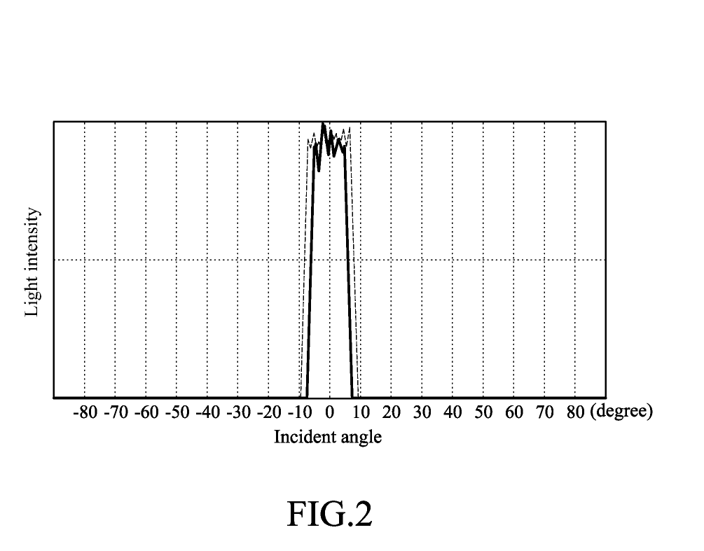

FIG. 2 is a schematic view of the corresponding relationship between the incident angle and the light intensity according to the present invention. Referring to FIG. 2, when the incident angle of the light is compressed into 10 degrees, a preferred light intensity can be obtained, in other words, a preferred polarized light conversion efficiency can be obtained.

In view of the above, the illumination system of the present invention improves the efficiency of the subsequent light processes (for example, light coupling and polarized light conversion) by converging the angles of the light with lens module. Moreover, the three light sources are separated with the light coupling module, so as to solve the problem of heat dissipation of high power light sources or array LED light sources, thereby improving the color of the illumination system through the light coupling module.

What is claimed is:

1. An illumination system, comprising:
at least one light source, capable of generating light of at least three wavelength sections;
at least three integrator modules, for receiving the light of the wavelength sections and performing a uniformization process on the light of the wavelength sections;
at least three first lens modules, for receiving the light after the uniformization process and converging angles of the light into a predetermined range;
a light coupling module, for receiving the converged light and performing a light-coupling process on the light; and
a polarization conversion module, for receiving the light after the light-coupling process and performing a polarization conversion process on the light.

2. The illumination system according to claim 1, wherein the angle of the light incident to the polarization conversion module is reduced by the lens modules.

3. The illumination system according to claim 1, comprising a second lens module, for stacking the light after the polarization conversion process on a liquid crystal panel.

4. The illumination system according to claim 1, wherein each integrator module has an entrance face and an exit face, the entrance face receives the light generated by the at least one light source, a virtual light source array is formed on the entrance face, the light exited from the exit face pass through the first lens module and form a real light source array corresponding to the virtual light source array, and the polarization conversion module is disposed on a position of the real light source array.

5. The illumination system according to claim 1, wherein the light coupling module comprises a first filter element and a second filter element, the first filter element reflects the light of a first wavelength section into the polarization conversion module and allows the light of a second wavelength section and the light of a third wavelength section to there-through, the second filter element reflects the light of the third wavelength section into the polarization conversion module and allows the light of the second wavelength section and the light of the first wavelength section to pass there-through.

6. The illumination system according to claim 5, wherein the whole section of the first wavelength section, the second wavelength section, and the third wavelength section covers the visible light section.

7. The illumination system according to claim 5, wherein the first filter element is perpendicular to the second filter element.

8. The illumination system according to claim 1, wherein the light coupling module is an un-polarized coupler.

9. The illumination system according to claim 1, wherein the light source is a halogen lamp, and the illumination system further comprises a light splitting element, for splitting the light generated by the halogen lamp into the light of the wavelength sections and introducing the light of the wavelength sections into the integrator modules.

10. The illumination system according to claim 1, wherein the light source is a high pressure mercury lamp, the illumination system further comprises a light splitting element for splitting the light generated by the high pressure mercury lamp into the light of the wavelength sections and introducing the light of the wavelength sections into the integrator modules.

11. The illumination system according to claim 1, wherein the light source is a light emitting diode (LED).
